(19) United States
(12) Patent Application Publication
(10) Pub. No.: US 2011/0006131 A1
(43) Pub. Date: Jan. 13, 2011

(54) CONTROL VALVE STRUCTURE OF ACCUMULATOR-TYPE FUEL INJECTION UNIT

(76) Inventor: Go Tomatsu, Kanagawa (JP)

Correspondence Address: WENDEROTH, LIND & PONACK, L.L.P., 1030 15th Street, N.W.,, Suite 400 East, Washington, DC, 20005-1503, US

(21) Appl. No.: 12/921,007

(22) PCT Filed: Oct. 26, 2009
(86) PCT No.: PCT/JP2009/068332

§ 371 Date: Sep. 13, 2010

(30) Foreign Application Priority Data
Nov. 7, 2008 (JP) 2008-286478

(51) Int. Cl. F02M 41/16; F02M 51/00

(52) U.S. Cl. 239/96; 239/585.5

(57) ABSTRACT

Provided is the structure of a control valve of accumulator fuel injection equipment wherein an adverse effect by bounce can be reduced by a low-cost means without requiring any special device in the control valve structure of accumulator fuel injection equipment. The control valve structure of accumulator fuel injection equipment is characterized in that the cross-sectional shape at the distal end of a control valve (8) along the central axis line thereof is constituted in such a manner that a bend consisting of at least one inflection point (Z1) is formed, a first face portion (3a) is formed on the root side from the bend, a second face portion (3c) is formed on the distal end side, the first face portion (3a) abuts on the seat portion (2a) of a nozzle body to form a fully closed position, a variation in the area of an opening which is formed between the first face portion (3a) and the seat portion (2a) is smaller than a fixed ratio when the inflection point (Z1) is lifted from the fully closed position to the seat portion (2a), and a variation in the area of an opening which is formed between the second face portion (3c) and the seat portion (2a) is larger than the fixed ratio for the lift when the lift of the inflection point (z1) is larger than the lift of the seat portion (2a).

### BACKGROUND OF THE INVENTION

1. Field of the Invention

The present invention relates to a control valve structure of an accumulator-type fuel injection unit structured such that high-pressure fuel inside a fuel storage is injected into a combustion chamber through an injection hole by releasing a control valve and lifting a nozzle needle valve.

2. Description of the Related Art

FIG. 6 is a sectional view illustrating an example of a fuel injection unit of an accumulator-type fuel injection unit.

FIG. 6 illustrates a fuel injection unit 100 having a nozzle body 2 equipped with an injection hole 14 at the distal end thereof for injecting the fuel and a nozzle needle valve 3 within the nozzle body such that the needle valve can freely reciprocate.

Accordingly, when fuel is not being injected, a tip of the nozzle needle valve 3 touches a seat portion 2b of the nozzle body 2 and the high-pressure fuel is stored in the fuel storage 13.

The high-pressure fuel being supplied from a high-pressure fuel pump for producing high-pressure fuel is introduced to a pressure accumulator 1 in which the pressure of the fuel is kept at a prescribed high pressure. The time when the high-pressure fuel is introduced is controlled by the opening/closing of a control valve of an electromagnetic valve.

The high-pressure fuel from the accumulator 1 is split into a first fuel passage 12 and a second fuel passage 12a. The first fuel passage 12 is connected to the fuel storage 13 in communication with the nozzle needle valve 3.

The second fuel passage 12a is connected to a control chamber 4 via an orifice. The control chamber 4 is formed in contact with a top surface of the nozzle needle valve 3 and the needle valve 3 is pushed down by the control chamber 4.

The control valve is actuated by a solenoid valve device 11s inside which the control valve 8 is fit slidably. When the control valve 8 is pulled upward by a solenoid coil, the control valve 8 opens a control port 7 (5 is an orifice) and the control chamber 4 so that the control chamber opens to a leak line 10. As the solenoid device is already know, it will not be explained further in detail.

Specifically, in the fuel injection unit 100, when the control valve 8 is pulled upward by the solenoid coil of the solenoid valve device 11s and the control port 7 opens, the force for opening the nozzle needle valve 3 is released.

By this, as the control chamber 4 is open to the leak line 10, the pressure of the high-pressure fuel stored in the fuel storage 14 via the first fuel passage 12 acts upward from the bottom side of the nozzle needle valve 3 so as to open the nozzle needle valve by moving the nozzle needle valve 3 away from the seat portion 2b.

Next, the high-pressure fuel inside the fuel storage 13 is injected to the combustion chamber of an engine through the injection hole 14 of the nozzle body 2 via the seat portion 2b.

The operation of the solenoid device 11s is controlled by a valve control device 15 based on a detection value of hydraulic pressure P of the accumulator 1 and a detection value of the rotation speed of the engine by an engine rotation speed detector 17.

In the fuel injection unit 100, the control valve 8 opens the control port 7 and the control chamber 4 and the control chamber opens to the leak line 10 and thus the nozzle needle valve 3 is moved upward away from the seat portion 2b so as to open the nozzle needle valve 3.

The injection control is performed by moving the control valve 8 upward and downward and the rotation speed of the engine can accelerate the injection control, which causes a bounce of the control valve 8 by the seating impact thereof.

As illustrated in FIG. 7 (A), the control valve 8 repeats the seating and removing from the seat portion 2a of the nozzle body 2. And as indicated with a lift line Y in FIG. 7 (B), during the seating or removing of the control valve 8, the opening area of the control valve 8 changes linearly with respect to the lift thereof.

Thus, when the movement of the control valve 8 causes the bounce, the operation of the nozzle needle valve 3 becomes unstable such as the needle valve opening again and the fuel injection characteristics become unstable.

Patent Document 1 (JP2004-346856A) and Patent Document 2 (JP6-14464U) respectively propose measure against the bounce issue.

Patent Document 1 proposes to install a vibration-proof member 18 at a moving part so as to reduce the bounce of the nozzle needle valve 34.

And Patent Document 2 proposes to provide a switch valve 20 for switching the flow amount of the fuel inside a seating portion so as to reduce the bounce when a poppet valve seats on the seating portion.

In the fuel injection unit of the accumulator type, the opening/closing of the control valve 8 is controlled by ON/OFF of the solenoid device 11s and the opening/closing of the control valve 8 is accelerated depending on the rotation speed of the engine, resulting in the bounce of the control valve during the seating.

The bounce may cause unwanted fuel leakage from the control chamber 4 which disturbs the hydraulic pressure recovery of the fuel inside the control chamber 4 and renders the movement of the nozzle needle valve unstable, resulting in affecting the fuel injection characteristic adversely.

The occurrence of the bounce is due to the unwanted leakage of the high-pressure fuel from the accumulator 1 by the pump and usually accompanied by the deterioration of a fuel consumption rate due to the increased workload of the pump and the capacity shortage of the pump.

To take measures against the issues, Patent Document 1 proposes to install a vibration-proof member 18 at a moving part so as to reduce the bounce of the nozzle needle valve 34 and Patent Document 2 proposes to provide a switch valve 20 for switching the flow amount of the fuel inside a seating portion so as to reduce the bounce when a poppet valve seats on the seating portion. However, according to both of the documents, a special device for removing the bounce, i.e. the vibration-proof member or the switch valve is needed, which raise the unit cost or requires more work to adjust the valve in the case of using the switch valve.

### SUMMARY OF THE INVENTION

In view of the problems above, an object of the present invention is to provide a control valve structure of an accumulator-type fuel injection unit wherein the generation of the bounce can be reduced by a low-cost means without requiring any special device.

To achieve the above object, the present invention provides a structure of a control valve of an accumulator-type fuel injection unit which comprises: a nozzle body having an injection hole; a nozzle needle valve that is fit inside the nozzle body in such a manner that the nozzle needle valve can slidably reciprocate inside the nozzle body, the nozzle needle valve having a tip that comes in contact with a seating portion of the nozzle body; an accumulator that accumulates high-pressure fuel; a control chamber to which a portion of the high-pressure oil accumulated in the accumulator is supplied as control oil so as to push the nozzle needle valve against the seating portion of the nozzle body; and a control valve that opens the control chamber to outside by a solenoid electromagnetic valve so as to lift the nozzle needle valve from the seating portion of the nozzle body, the high-pressure fuel stored in the accumulator being injected into a combustion chamber via the injection hole when the control valve is opened to lift the nozzle needle valve, wherein: the control valve has a tip whose cross-sectional shape along a central axis line of the control valve includes a first face on a root side and a second face on a tip side, the cross-sectional shape of the tip of the control valve being bent at a bend section that has at least one inflection point and is arranged between the first and second faces, the first face coming into contact with a seating portion of the nozzle body to fully close the control valve; a ratio of a change in an opening area formed between the first face and the seating portion of the nozzle body to a lift amount of the control valve is less than a prescribed value from a state in which the control valve is fully closed to a state in which the control valve is lifted so that the bend section reaches a height of the seating portion; and ratio of a change in an opening area formed between the second face and the seating portion of the nozzle body to the lift amount of the control valve is greater than the prescribed value in a state where the control valve is lifted so that the bend section is in a higher position than the seating portion.

It is preferable that the cross-sectional shape of the tip of the control valve further includes a third face formed between the first and second faces so that an opening area formed between the third face and the seating portion of the nozzle body does not change with the lift amount of the control valve.

It is also preferable that the second face is directly formed on the root side without the first face so that the second face comes in contact with the seating portion of the nozzle body, a tip end of the second face being a flat surface cut at a right angle to the central axis line of the control valve.

Moreover, the present invention also provides a structure of a control valve of an accumulator-type fuel injection unit which comprises: a nozzle body having an injection hole; a nozzle needle valve that is fit inside the nozzle body in such a manner that the nozzle needle valve can slidably reciprocate inside the nozzle body, the nozzle needle valve having a tip that comes in contact with a seating portion of the nozzle body; an accumulator that accumulates high-pressure fuel; a control chamber to which a portion of the high-pressure oil accumulated in the accumulator is supplied as control oil so as to push the nozzle needle valve against the seating portion of the nozzle body; and a control valve that opens the control chamber to outside by a solenoid electromagnetic valve so as to lift the nozzle needle valve from the seating portion of the nozzle body, the high-pressure fuel stored in the accumulator being injected into a combustion chamber via the injection hole when the control valve is opened to lift the nozzle needle valve, wherein: the control valve has a tip whose cross-sectional shape along a central axis line of the control valve includes a first face on a root side and a second face on a tip side, the cross-sectional shape of the tip of the control valve being bent at a bend section that has at least one inflection point and is arranged between the first and second faces; the cross-sectional shape of the seating portion along the central axis line of the control includes a first taper portion inclining with respect to the central axis line of the control valve and a second taper portion formed on an outer side of the first taper portion with a greater angle than the first taper portion by a set amount, the first taper portion coming into contact with the bend section of the tip of the control valve to fully close the control valve; a ratio of a change in an opening area formed between the first face and the first taper portion to a lift amount of the control valve is less than a prescribed value from a state in which the seating portion is fully closed to a low lift state in which the control valve is lifted so that the bend section reaches an intersection point of the first and second taper portions; and a ratio of a change in an opening area formed between the second face and the second taper portion to a lift amount of the control valve is greater than the prescribed value in a high lift state in which the control valve is lifted so that the bend section is in a higher position than the intersection point.

According to the present invention, the control valve who comes in contact with the seating portion of the nozzle body has a tip whose cross-sectional shape along a central axis line of the control valve includes a first face on a root side and a second face on a tip side, the cross-sectional shape of the tip of the control valve being bent at a bend section that has at least one inflection point and is arranged between the first and second faces, the first face coming into contact with a seating portion of the nozzle body to fully close the control valve; a ratio of a change in an opening area formed between the first face and the seating portion of the nozzle body to a lift amount of the control valve is less than a prescribed value from a state in which the control valve is fully closed to a state in which the control valve is lifted so that the bend section reaches a height of the seating portion; and a ratio of a change in an opening area formed between the second face and the seating portion of the nozzle body to the lift amount of the control valve is greater than the prescribed value in a state where the control valve is lifted so that the bend section is in a higher position than the seating portion.

As illustrated in FIG. 1 (A) and FIG. 1 (B), the sectional shape of the tip of the control valve along the central axis line of the control valve 8 includes the bend section with one inflection point Z1 and the first face 3a, and the first face 3a is formed so that the ratio of the change in the opening area between the first face 3a and the seating portion 2a to the lift amount of the nozzle needle valve 3 from the fully-closed state to the low-lift state is less than the prescribed value. Specifically, the first face 3a is formed so that the ratio of the change is smaller than the prescribed amount shown as the lift line Y.

By forming the first face 3a, the ratio of the change in the opening area to the lift mount during the bounce is smaller than the conventional case indicated with the lift line Y. Thus, the opening area between the first face 3a and the seating portion 2a becomes smaller and the fuel leak is reduced, resulting in suppressing the unstable performance such as the needle valve 3 opening again.

Further, the second face 3c is formed so that the ratio of the change in the opening area of the control valve 8 to the lift amount is greater than the prescribed value when the second face 3c comes to a height position of the seating portion 2a in the high lift state wherein the control valve is lifted so that the bend section is in a higher position than the seating portion 2a, as illustrated in FIG. 1 (A) and FIG. 1 (B). With such high lift of the control valve, the opening area between the second face 3c and the seat portion 2a is increased as shown by the line X in FIG. 2 (B).

Furthermore, by forming the first face 3a formed so that the ratio of the change in the opening area is smaller than the prescribed value, in the low-lift state wherein the change in the opening area during the bounce becomes smaller than the prescribed value and the opening area between the first face 3a and the seating portion also becomes small. As a result, the amount of the fuel leak from the first face 3a is reduced, thereby suppressing the reopening of the nozzle valve 3.

Meanwhile, by forming the second face 3c so that the ratio of the change in the opening area is greater than the prescribed value, in the high-lift state wherein the control valve is lifted so that the second face 3c is lifted to a height position of the seating portion 2a. As a result, the opening area between the second face and the seating portion 2a is opened in the manner similar to the conventional case.

Therefore, according to the present invention, the cross-sectional shape of the tip of the control valve along the central axis line thereof can be simply adjusted with a low-cost means without arranging a specific device so as to reduce the adverse effect due to the occurrence of the bounce in the low lift state. As a result, the structure of the control valve of the accumulator-type fuel injection unit can be obtained which can suppress the reopening of the nozzle needle valve 3 and uses the control valve in the manner similar to the conventional control valve in the high-lift state.

Further, the cross-sectional shape of the tip of the control valve 8 further includes a third face 3b formed between the first face and a second face so that an opening area formed between the third face 3b and the seating portion of the nozzle body does not change with the lift amount of the control valve 8.

As illustrated in FIG. 1 (A) and FIG. 1 (B), the third face 3b of the control valve 8 is formed so that the opening area formed between the third face 3b and the seating portion 2a does not change with the lift amount. As a result, the height of the dimension shown in FIG. 1 (B) can be controlled so as to adjust the lift mount of the control valve 8, which can affect the lift of the nozzle needle valve 3 due to the bounce.

Furthermore, the second face is directly formed on the root side of the control valve 8 without forming the first face so that the second face 3e comes in contact with the seating portion 2a of the nozzle body and a tip end of the second face 3e is configured as a flat surface cut at a right angle to the central axis line of the control valve.

With this structure, as shown in FIG. 3 (A) and FIG. 3 (B), in the low-lift state, the second face 3e comes in contact with the seating portion 2a so that the ratio of the change in the opening area to the lift amount becomes greater than the prescribed value. The ratio of the change in the opening area changes away from the ratio Y as indicated with X in FIG. 3 (B) when the inflection point 3f is lifted to or higher than the seating portion 2a. And at the cut surface 3g, i.e. the tip end of the second face 3e, the opening area rapidly increases.

Moreover, the ratio of the change changes at the inflection point 3f and follows the slope X in comparison with the conventional case shown with the lift line Y. Therefore, the stroke of the second preferred embodiment is smaller than that of the conventional case by U as illustrated in FIG. 3 (B).

Therefore, the operation of the control valve 8 can be shortened by the stroke U. In the amount corresponding to the stroke U, the impact of seating the control valve is reduced and the occurrence of the bounce is reduced as well, thereby suppressing the unwanted fuel leakage from the control chamber 4. Further, the shortened suction step of the solenoid valve reduces the workload by the solenoid, which equals to saving electric power saving of the solenoid valve and also space saving.

Moreover, as shown in FIG. 4 and FIG. 5, the control valve 8 has a tip whose cross-sectional shape along a central axis line 3s of the control valve includes a first face 3i on a root side and a second face 3j on a tip side, the cross-sectional shape of the tip of the control valve being bent at a bend section that has at least one inflection point 3t and is arranged between the first and second faces, and the cross-sectional shape of the seating portion 2a includes a first taper portion 2c and a second taper portion 2f. The first taper portion 2c comes in contact with the bend section at the inflection point 3t to fully close the control valve 8.

The first face 3i of the control valve 8 and the first taper portion 2c of the seating portion 2a are formed so that a ratio of a change in an opening area formed between the first face 3i and the first taper portion 2c to a lift amount of the control valve is less than a prescribed value from the fully-closed state to a low lift state (h1) in which the control valve 8 is lifted so that the bend section (inflection point 3t) reaches an intersection point K of the first and second taper portions 2c and 2f.

And the second face 3j and the second taper portion 2f are formed so that a ratio of a change in an opening area formed between the second face 3j and the second taper portion 2f to a lift amount of the control valve is greater than the prescribed value in a high lift state (h2) in which the control valve 8 is lifted so that the bend section (inflection point 3t) is in a higher position than the intersection point K as indicated with the slope X in FIG. 5. FIG. 4 also shows a control port 7.

Moreover, the second taper portion 2f is formed on an outer side of the first taper portion 2c with a greater angle than the first taper portion 2c.

The second taper portion 2f is formed on the outer side of the first taper portion 2c with a greater angle (θ: sharp angle) than the first taper portion 2c. The angle θ may be reduced in the range that does not affect the opening area between the second face 3j and the second taper portion 2f so as to minimize the cavitation erosion caused by the sudden increase of the opening area.

### BRIEF DESCRIPTION OF THE DRAWINGS

FIG. 1 (A) is an enlarged view of the tip of the control valve illustrating a first preferred embodiment of the present invention and FIG. 1 (B) is a motion diagram of the control valve.

FIG. 2 shows motion diagrams of the control valve and a control chamber.

FIG. 3 (A) is an enlarged view of the tip of the control valve illustrating a second preferred embodiment of the present invention and FIG. 3 (B) is a motion diagram of the control valve.

FIG. 4 shows an enlarged view of the tip of the control valve illustrating a third preferred embodiment of the present invention. FIG. 4 (A) is a fully closed state, FIG. 4 (B) is a low lift state and FIG. 4 (C) is a high lift state.

FIG. 5 is a motion diagram of the control valve in relation to the third preferred embodiment of the present invention.

FIG. 6 is a sectional view illustrating an example of the fuel injection unit of an accumulator-type to which the present invention is applied.

FIG. 7 (A) is an enlarged view of the tip of conventional control valve corresponding to FIG. 1 and FIG. 7 (B) is a motion diagram of the conventional control valve.

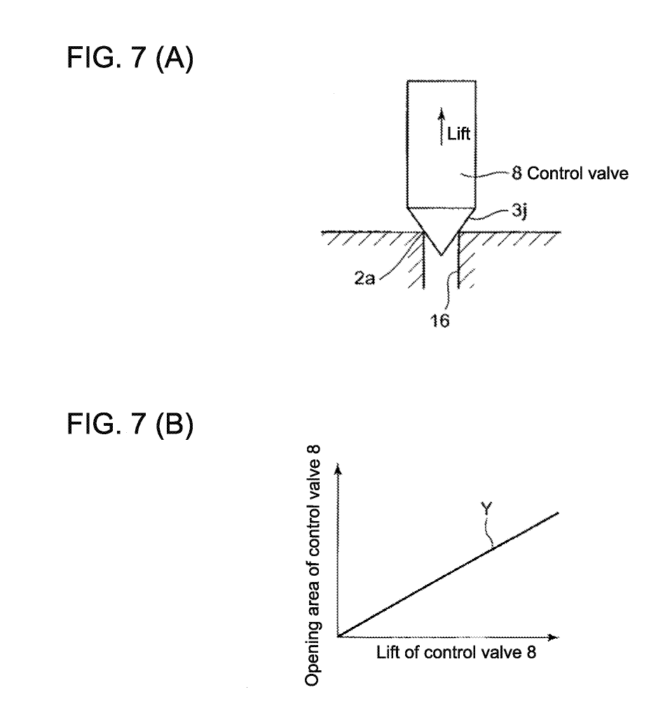

FIG. 8 shows motion diagrams of the conventional control valve and a control chamber in relation to the related art.

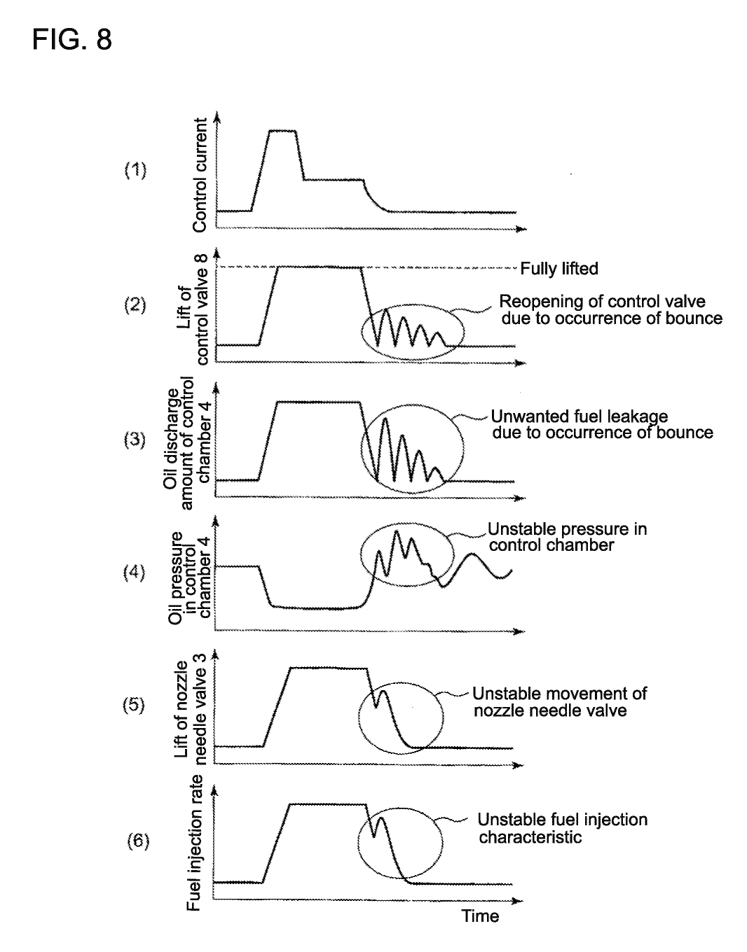

### DETAILED DESCRIPTION OF THE PREFERRED EMBODIMENTS

A preferred embodiment of the present invention will now be described in detail with reference to the accompanying drawings. It is intended, however, that unless particularly specified, dimensions, materials, shape, its relative positions and the like shall be interpreted as illustrative only and not limitative of the scope of the present.

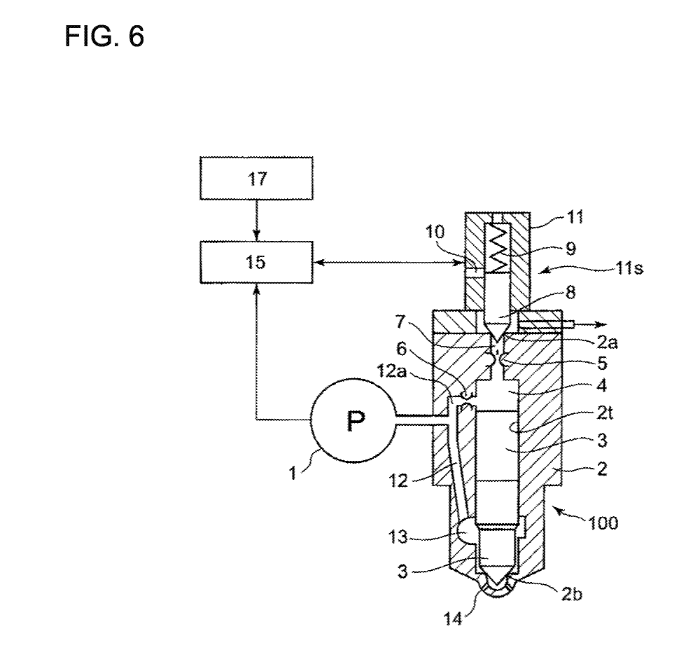

FIG. 6 is a sectional view illustrating an example of the fuel injection unit of an accumulator-type to which the present invention is applied.

FIG. 6 shows a fuel injection unit 100 which comprises a nozzle body 2 having injection holes 14, and a nozzle needle valve 3 that is fit inside the nozzle body 2 in such a manner that the nozzle needle valve 3 can slidably reciprocate inside the nozzle body 2.

Thus, in the fully-closed state, the tip of the needle valve 3 is in contact with a seat portion 2b of the nozzle body 2 so that the high pressure fuel is stored in a fuel storage 13.

The high-pressure fuel supplied from a high-pressure fuel pump for producing high-pressure fuel, is introduced to a pressure accumulator 1 in which the pressure of the fuel is kept at a prescribed high pressure. The time when the high-pressure fuel is introduced is controlled by the opening/closing of a control valve 8 having an electromagnetic valve.

The high-pressure fuel from the accumulator 1 is split into a first fuel passage 12 and a second fuel passage 12a. The first fuel passage 12 is connected to the fuel storage 13 in communication with the nozzle needle valve 3.

The second fuel passage 12a is connected to a control chamber 4 via an orifice 6. The control chamber 4 is formed to be in contact with a top surface of the nozzle needle valve 3, thereby the control chamber 4 pushes the needle valve 3 downward.

The control valve 8 is actuated by a solenoid valve device 11s inside which the control valve 8 is fit slidably. When the control valve 8 is pulled upward by a solenoid coil 9, the control valve 8 opens a control port 7 (5 is an orifice) and the control chamber 4 so that the control chamber opens to a leak line 10. As the solenoid device is an already known device, it will not be explained further in details herein.

Specifically, in the fuel injection unit 100, when the control valve 8 is pulled upward by the solenoid coil of the solenoid valve device 11s and the control port 7 opens, the force exerted on the nozzle needle valve 3 is released.

By this, as the control chamber 4 is open to the leak line 10, the pressure of the high-pressure fuel stored in the fuel storage 13 via the first fuel passage 12 acts upward from the bottom side of the nozzle needle valve 3 so as to open the nozzle needle valve by moving the nozzle needle valve 3 away from the seat portion 2b.

Next, the high-pressure fuel inside the fuel storage 13 is injected to the combustion chamber of an engine through the injection holes 14 of the nozzle body 2 via the seat portion 2b.

The operation of the solenoid device 11s is controlled by a valve control device 15 based on a detection value of hydraulic pressure P of the pressure accumulator 1 and a detection value of the rotation speed of the engine detected by an engine rotation speed detector 17.

In the fuel injection unit 100, the control valve 8 opens the control port 7 and the control chamber 4, and the control chamber opens to the leak line 10 and thus the nozzle needle valve 3 is moved upward away from the seat portion 2b so as to open the nozzle needle valve 3.

The injection control is performed by moving the control valve 8 upward and downward and the rotation speed of the engine can accelerate the injection control, which causes an issues of the bounce of the control valve 8 by the seating impact thereof.

The present invention was made to reduce the bounce of the control valve 8.

### First Preferred Embodiment

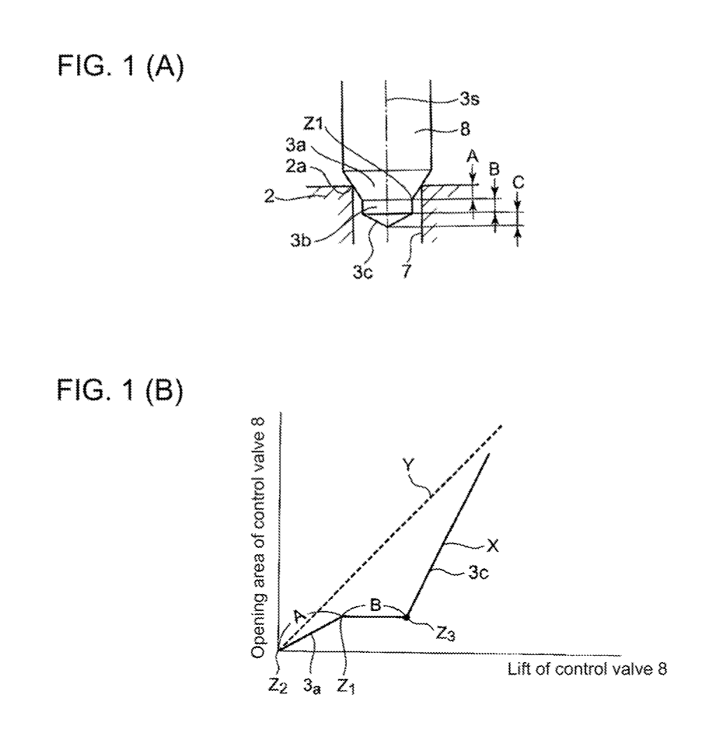

FIG. 1 (A) is an enlarged view of the tip of the control valve illustrating the first preferred embodiment of the present invention and FIG. 1 (B) is a motion diagram of the control valve.

As illustrated in FIG. 1 (A), the tip of the control valve 8 which comes in contact with a seating portion 2a of the nozzle body 2 has a cross sectional shape along a central axis line 3s of the control valve being structured as below.

The tip of the control valve 8 has a bend section that has one inflection point Z1 and a first face 3a. And a ratio of a change in an opening area between the first face 3a and a seating portion 2a of the nozzle body to a lift amount of the control valve from a fully-closed state to a low-lift is less than a prescribed value of the line Y of the conventional case (ref. FIG. 1 (B)). The fully-closed state is when the control valve 8 is fully closed and the low-lift state is when the control valve is lifted so that the bend section (the inflection point Z1) reaches a height of the seating portion 2a (the dimension A in FIG. 1 (A)).

Next, the cross-sectional shape of the tip of the control valve 8 further includes a third face 3b formed between the first face 3a and a second face 3c as will be described hereinafter so that an opening area formed between the third face 3b and the seating portion 2a of the nozzle body 2 does not change with the lift amount of the control valve 8 (the dimension B in FIG. 1 (A)).

In this manner, the third face 3b of the control valve 8 is formed so that the opening area formed between the third face 3b and the seating portion 2a does not change with the lift amount. As a result, the height of the dimension B shown in FIG. 1 (B) can be controlled so as to adjust the lift mount of the control valve 8, which can affect the lift of the nozzle needle valve 3 due to the bounce.

The second face 3c of the tip is formed so that a ratio of a change in an opening area formed between the second face 3c and the seating portion 2a of the nozzle body 2 to the lift amount of the control valve 8 is greater than the prescribed value in a high-lift state where the control valve is lifted so that the bend section is in a higher position than the seating portion 2a, i.e. the inflection point Z1 (the dimension C of FIG. 1 (A)). Specifically, in reference to FIG. 1 (B), the second face 3c comes to a height position of the seating portion 2a so that the ratio of the change shown as the line X is greater than the prescribed value shown as the line Y of the conventional case.

Therefore, according to the first preferred embodiment, the sectional shape of the tip of the control valve along the central axis line 3s of the control valve 8 includes the bend section with one inflection point Z1 and the first face 3a, and the first face 3a is formed so that the ratio of the change in the opening area between the first face 3a and the seating portion 2a to the lift amount of the nozzle needle valve 3 from the fully-closed state to the low-lift state is less than the prescribed value. Specifically, the first face 3a is formed so that the ratio of the change shown by the line X in the area A is smaller than the prescribed amount shown as the lift line Y of the conventional control valve.

By forming the first face 3a, the ratio of the change in the opening area to the lift mount during the bounce is smaller than the conventional case indicated with the lift line Y. Thus, the opening area between the first face 3a and the seating portion 2a becomes smaller and the fuel leak is reduced, resulting in suppressing the unstable performance such as the needle valve 3 opening again.

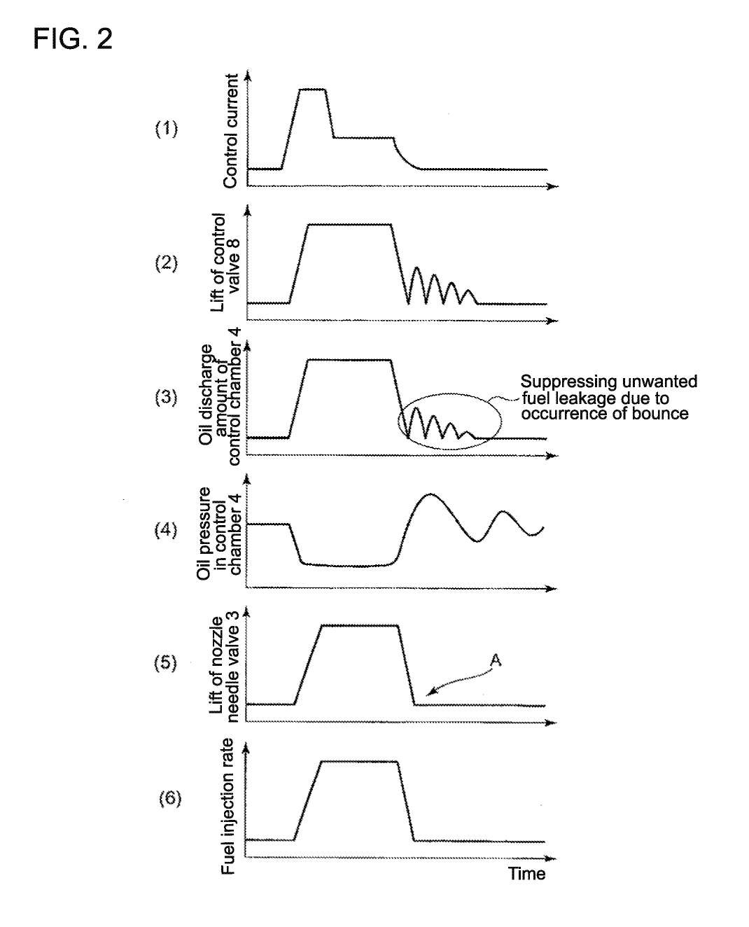

Further, the second face 3c is formed so that the ratio of the change in the opening area of the control valve 8 to the lift amount is greater than the prescribed value when the second face 3c comes to a height position of the seating portion 2a in the high lift state wherein the control valve is lifted so that the bend section is in a higher position than the seating portion 2a, as illustrated in FIG. 1 (A) and FIG. 1 (B). With such high lift of the control valve, the opening area between the second face 3c and the seat portion 2a is increased as shown by the line X in FIG. 2 (B).

Furthermore, by forming the first face 3a formed so that the ratio of the change in the opening area is smaller than the prescribed value, in the low-lift state wherein the change in the opening area during the bounce becomes smaller than the prescribed value and the opening area between the first face 3a and the seating portion also becomes small. As a result, the amount of the fuel leak from the first face 3a is reduced, thereby suppressing the bounce.

Meanwhile, by forming the second face 3c so that the ratio of the change in the opening area is greater than the prescribed value, in the high-lift state wherein the control valve is lifted so that the second face 3c is lifted to a height position of the seating portion 2a. As a result, the opening area between the second face and the seating portion 2a is opened in the manner similar to the conventional case.

By suppressing the unwanted fuel leakage from the control chamber 4 due to the bounce in response to the lift of the control valve 8 in the manner described above, the unstable performance of the nozzle needle valve 3 such as the reopening thereof is prevented at the lift (indicated as A in FIG. 2 (5)), thereby achieving fuel combustion characteristics in a stable manner (FIG. 2 (6)).

Therefore, according to the first preferred embodiment, the cross-sectional shape of the tip of the control valve 8 along the central axis line thereof is adjusted so as to reduce the adverse effect due to the occurrence of the bounce in the low lift state and use the control valve 8 in the manner similar to the conventional control valve in the high-lift state without needing a special device.

### Second Preferred Embodiment

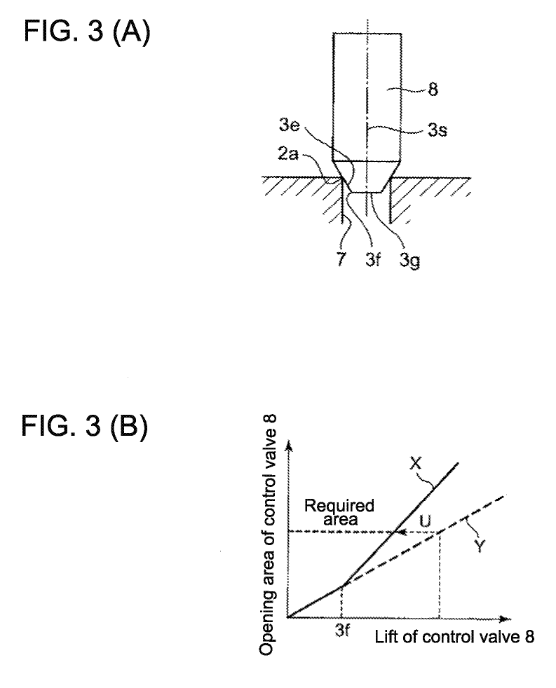

FIG. 3 (A) is an enlarged view of the tip of the control valve illustrating a second preferred embodiment of the present invention and FIG. 3 (B) is a motion diagram of the control valve.

In FIG. 3 illustrating the second preferred embodiment, the second face 3e is directly formed on the root side of the control valve 8 without forming the first face 3a so that the second face 3e comes in contact with the seating portion 2a of the nozzle body and a tip end of the second face 3e is configured as a flat surface cut at a right angle to the central axis line 3s of the control valve 8.

As shown in FIG. 3 (A) and FIG. 3 (B), in the low-lift state, the second face 3e comes in contact with the seating portion 2a so that the ratio of the change in the opening area to the lift amount becomes greater than the prescribed value. The ratio of the change in the opening area changes away from the ratio Y as indicated with X in FIG. 3 (B) when the inflection point 3f is lifted to or higher than the seating portion 2a. And at the cut surface 3g, i.e. the tip end of the second face 3e, the opening area rapidly increases.

With the above structure, the ratio of the change changes at the inflection point 3f and follows the slope X in comparison with the conventional case shown with the lift line Y. Therefore, the stroke of the second preferred embodiment is smaller than that of the conventional case (lift line Y) by U as illustrated in FIG. 3 (B).

Therefore, the operation of the control valve 8 can be shortened by the stroke U, thereby shortening the suction step of the solenoid valve and reducing the occurrence of the bounce resulting the reduction of the unwanted fuel leakage from the solenoid.

### Third Preferred Embodiment

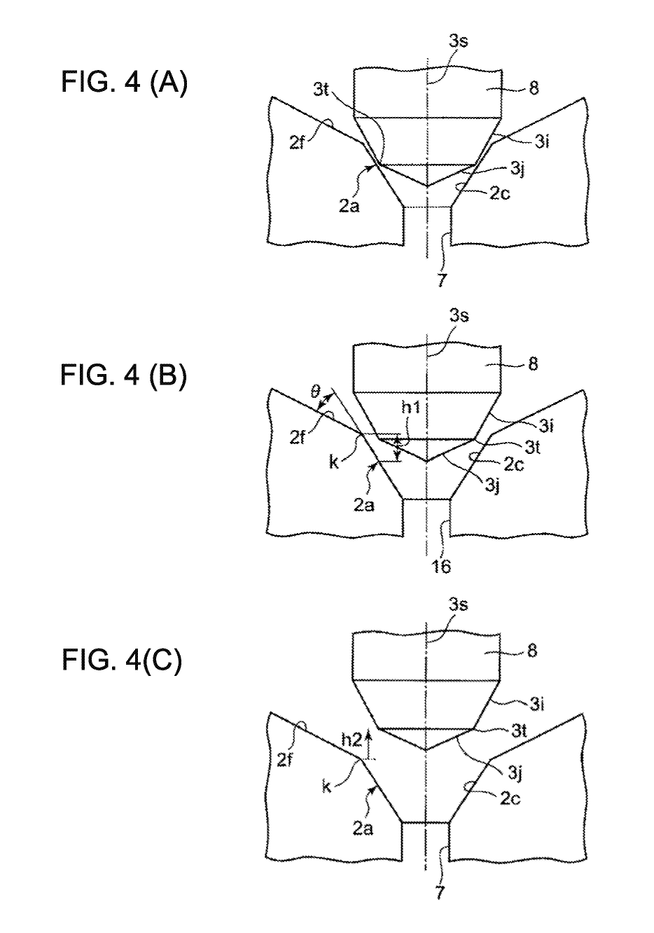

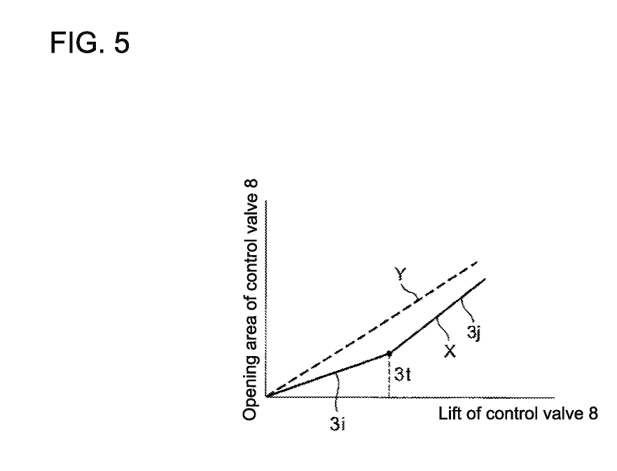

FIG. 4 is an enlarged view of the tip of the control valve illustrating a third preferred embodiment of the present invention. FIG. 4 (A) is a fully closed state, FIG. 4 (B) is a low lift state and FIG. 4 (C) is a high lift state. FIG. 5 is a motion diagram of the control valve in relation to the third preferred embodiment.

In the third preferred embodiment, the control valve 8 has a tip whose cross-sectional shape along a central axis line 3s of the control valve includes a first face 3i on a root side and a second face 3j on a tip side, the cross-sectional shape of the tip of the control valve being bent at a bend section that has at least one inflection point 3t and is arranged between the first and second faces, and the cross-sectional shape of the seating portion 2a includes a first taper portion 2c and a second taper portion 2f. The first taper portion 2c comes in contact with the bend section at the inflection point 3t to fully close the control valve 8.

The first face 3i of the control valve 8 and the first taper portion 2c of the seating portion 2a are formed so that a ratio of a change in an opening area formed between the first face 3i and the first taper portion 2c to a lift amount of the control valve is less than a prescribed value from the fully-closed state to a low lift state (h1) in which the control valve 8 is lifted so that the bend section (inflection point 3t) reaches an intersection point K of the first and second taper portions 2c and 2f.

And the second face 3j and the second taper portion 2f are formed so that a ratio of a change in an opening area formed between the second face 3j and the second taper portion 2f to a lift amount of the control valve is greater than the prescribed value in a high lift state (h2) in which the control valve 8 is lifted so that the bend section (inflection point 3t) is in a higher position than the intersection point K as indicated with the slope X in FIG. 5. FIG. 4 also shows a control port 7.

Moreover, the second taper portion 2f is formed on an outer side of the first taper portion 2c with a greater angle than the first taper portion 2c.

The second taper portion 2f is formed on the outer side of the first taper portion 2c with a greater angle (θ: sharp angle) than the first taper portion 2c. The angle θ may be reduced in the range that does not affect the opening area between the second face 3j and the second taper portion 2f so as to minimize the cavitation erosion caused by the sudden increase of the opening area.

In the first, second and third preferred embodiments, it is also possible to form the first faces 3a and 3i, the second faces 3c, 3e and 3j, the first taper portion 2c and the second taper portion 2f so that the surface thereof is a curved surface instead of the flat surface. In the preferred embodiments, the surfaces of the above portions are curved surfaces in a circumferential direction thereof. Thus, by changing the surfaces thereof from the curved surfaces to conical surfaces, the outline of the tip becomes a curved line from the straight line.

### INDUSTRIAL APPLICABILITY

According to the present invention, a control valve structure of an accumulator-type fuel injection unit wherein the adverse effect of the bounce can be reduced by a low-cost means without requiring any special device.

1. A structure of a control valve of an accumulator-type fuel injection unit which comprises: a nozzle body having an injection hole; a nozzle needle valve that is fit inside the nozzle body in such a manner that the nozzle needle valve can slidably reciprocate inside the nozzle body, the nozzle needle valve having a tip that comes in contact with a seating portion of the nozzle body; an accumulator that accumulates high-pressure fuel; a control chamber to which a portion of the high-pressure oil accumulated in the accumulator is supplied as control oil so as to push the nozzle needle valve against the seating portion of the nozzle body; and a control valve that opens the control chamber to outside by a solenoid electromagnetic valve so as to lift the nozzle needle valve from the seating portion of the nozzle body, the high-pressure fuel stored in the accumulator being injected into a combustion chamber via the injection hole when the control valve is opened to lift the nozzle needle valve, wherein:
the control valve has a tip whose cross-sectional shape along a central axis line of the control valve includes a first face on a root side and a second face on a tip side, the cross-sectional shape of the tip of the control valve being bent at a bend section that has at least one inflection point and is arranged between the first and second faces, the first face coming into contact with a seating portion of the nozzle body to fully close the control valve;
a ratio of a change in an opening area formed between the first face and the seating portion of the nozzle body to a lift amount of the control valve is less than a prescribed value from a state in which the control valve is fully closed to a state in which the control valve is lifted so that the bend section reaches a height of the seating portion; and
a ratio of a change in an opening area formed between the second face and the seating portion of the nozzle body to the lift amount of the control valve is greater than the prescribed value in a state where the control valve is lifted so that the bend section is in a higher position than the seating portion.

2. The structure of the control valve of the accumulator-type fuel injection unit according to claim 1, wherein the cross-sectional shape of the tip of the control valve further includes a third face formed between the first and second faces so that an opening area formed between the third face and the seating portion of the nozzle body does not change with the lift amount of the control valve.

3. The structure of the control valve of the accumulator-type fuel injection unit according to claim 1, wherein the second face is directly formed on the root side without the first face so that the second face comes in contact with the seating portion of the nozzle body, a tip end of the second face being a flat surface cut at a right angle to the central axis line of the control valve.

4. A structure of a control valve of an accumulator-type fuel injection unit which comprises: a nozzle body having an injection hole; a nozzle needle valve that is fit inside the nozzle body in such a manner that the nozzle needle valve can slidably reciprocate inside the nozzle body, the nozzle needle valve having a tip that comes in contact with a seating portion of the nozzle body; an accumulator that accumulates high-pressure fuel; a control chamber to which a portion of the high-pressure oil accumulated in the accumulator is supplied as control oil so as to push the nozzle needle valve against the seating portion of the nozzle body; and a control valve that opens the control chamber to outside by a solenoid electromagnetic valve so as to lift the nozzle needle valve from the seating portion of the nozzle body, the high-pressure fuel stored in the accumulator being injected into a combustion chamber via the injection hole when the control valve is opened to lift the nozzle needle valve, wherein:
the control valve has a tip whose cross-sectional shape along a central axis line of the control valve includes a first face on a root side and a second face on a tip side, the cross-sectional shape of the tip of the control valve being bent at a bend section that has at least one inflection point and is arranged between the first and second faces;
the cross-sectional shape of the seating portion along the central axis line of the control includes a first taper portion inclining with respect to the central axis line of the control valve and a second taper portion formed on an outer side of the first taper portion with a greater angle than the first taper portion by a set amount, the first taper portion coming into contact with the bend section of the tip of the control valve to fully close the control valve;
a ratio of a change in an opening area formed between the first face and the first taper portion to a lift amount of the control valve is less than a prescribed value from a state in which the seating portion is fully closed to a low lift state in which the control valve is lifted so that the bend section reaches an intersection point of the first and second taper portions; and
a ratio of a change in an opening area formed between the second face and the second taper portion to a lift amount of the control valve is greater than the prescribed value in a high lift state in which the control valve is lifted so that the bend section is in a higher position than the intersection point.
